(19) United States
(12) Patent Application Publication
(10) Pub. No.: US 2009/0165960 A1
(43) Pub. Date: Jul. 2, 2009

(54) Tape binding device

(75) Inventor: Hiroshi Hataya, Osaka (JP)

Correspondence Address: RABIN & Berdo, PC, 1101 14TH STREET, NW, SUITE 500, WASHINGTON, DC, 20005, US

(73) Assignee: TAIYO SEIKI CO., LTD., Osaka (JP)

(21) Appl. No.: 12/213,430

(22) Filed: Jun. 19, 2008

(30) Foreign Application Priority Data
Dec. 28, 2007 (JP) 2007-340918

(51) Int. Cl. B29C 65/00

(52) U.S. Cl. 156/382

(57) ABSTRACT

A tape binding device includes a table. The table includes a tape passage groove allowing to pass a tape having a greater width than a width of a material to be bound. A loop forming mechanism for forming a loop of the tape includes a first belt conveying mechanism disposed below the table. The first belt conveying mechanism includes a plurality of conveying belts provided with spaces to be spaced apart in a direction perpendicular to a conveyance direction of the tape. The tape is sucked to the conveying belts and conveyed by sucking air through the spaces. Placing portions of plurality of placing members driven to an upper position by a driving mechanism place the material to be bound thereon located above the conveying belts of the first belt conveying mechanism. At least one of the placing portions is arranged to advance above the conveying belts through a space between the corresponding conveying belts.

### BACKGROUND OF THE INVENTION

1. Field of the Invention

The present invention relates to a tape binding device for binding a material to be bound with a tape.

2. Description of Related Arts

A tape binding device of this type binds the material to be bound by forming a loop of tape and tightening up the loop.

The tape binding device of this type is conventionally arranged such that the tape is advanced upward from below the tape passage groove formed in a table to place the material to be bound thereon and the loop is formed at an end of the advanced tape (see Japanese Unexamined Patent Publication No. 2003-20006 and WO95/019913).

As a consequence, the tape passage groove inevitably has a greater width than a tape width (tape width<groove width).

If a tape wider than the material to be bound is used (material width<tape width), the width of the tape passage groove must be greater than that of the material to be bound (material width<groove width). In this case, the material to be bound falls down from the tape passage groove.

Therefore, it is practically impossible to bind the material to be bound using the tape wider than the material to be bound.

### SUMMARY OF THE INVENTION

An object of the invention is to provide a tape biding device capable of binding the material to be bound with the tape wider than the material to be bound.

In a preferred embodiment of the invention, to accomplish the above object, a tape binding device is provided that includes a table formed with a tape passage groove to pass a tape having a greater width than a width of a material to be bound, placing members capable of placing the material to be bound thereon that is located above the tape passage groove, and a driving mechanism for driving the placing members to an upper position and to a lower position. The tape binding device further includes a loop forming mechanism including an air suction pump and a plurality of belt conveying mechanisms arranged in an annular configuration to form a loop of the tape. Each of the plurality of belt conveying mechanisms includes a plurality of conveying belts extended in parallel along a conveyance direction of the tape and provided with spaces to be spaced apart in a direction perpendicular to the conveyance direction. The air suction pump sucks air through the spaces thereby sucking the tape to the conveying belts. The plurality of belt conveying mechanisms include a first belt conveying mechanism disposed below the table. The placing members include a plurality of placing portions capable of placing the material to be bound thereon that is located above the conveying belts of the first belt conveying mechanism when the placing members are shifted to the upper position. At least one of the placing portions is arranged to advance above the conveying belts through a space between the corresponding conveying belts of the first belt conveying mechanism.

According to the embodiment, the material to be bound can be placed on the placing portions advanced above the conveying belts through the spaces between the conveying belts of the first belt conveying mechanism disposed below the table. Therefore, even a material to be bound which has a smaller width than that of the tape may be prevented from falling into the tape passage groove. As a result, binding is practically possible using a tape wider than the material to be bound.

### BRIEF DESCRIPTION OF THE DRAWINGS

FIG. 1 is a schematic front view showing a tape binding device according to one embodiment of the invention;

FIG. 2 is a schematic perspective view showing the tape binding device;

FIG. 3 is a schematic sectional view of an upper part of the tape binding device showing a state where a placing unit is moved up;

FIG. 4 is a sectional view taken on the line IV-IV in FIG. 3;

FIG. 5 is a partly broken perspective view showing a conveying belt;

FIG. 6 is a sectional view showing the conveying belt and a second pulley;

FIG. 7 is a sectional view taken on the line VII-VII in FIG. 3;

FIG. 8A is a schematic diagram of a connection between a second belt conveying mechanism and a third belt conveying mechanism showing a state immediately before tape transfer from the second belt conveying mechanisms to the third belt conveying mechanism;

FIG. 8B is a schematic diagram of the connection between the second belt conveying mechanism and the third belt conveying mechanism showing a state immediately after the tape transfer from the second belt conveying mechanism to the third belt conveying mechanism;

FIG. 9 is a schematic sectional view of the upper part of the tape binding device showing a state where the placing unit is moved down;

FIG. 10 is a schematic plan view showing a first belt conveying mechanism and the placing unit;

FIG. 11A is a sectional view taken on the line 11A-11A in FIG. 9 showing a state where placing members are at a lower position;

FIG. 11B is a sectional view taken on the line 11B-11B in FIG. 3 showing a state where the placing members are at an upper position;

FIG. 12 is a schematic diagram showing an arrangement of a conveying roller, the conveying belt and a neighborhood of a supplying mechanism;

FIG. 13 a schematic diagram of the arrangement of the conveying roller, the conveying belt and the neighborhood of the supplying mechanism showing a state where a tape T is conveyed while being sandwiched by the conveyor roller and the conveying belt therebetween;

FIG. 14 is a partly broken side view showing a cutting mechanism, a heating mechanism, a clamping mechanism and a driving mechanism including cams for driving these mechanisms;

FIG. 15 is a schematic front view of the cutting mechanism showing a state prior to cutting;

FIG. 16 is a schematic front view of the cutting mechanism showing a state after cutting;

FIG. 17 is a schematic front view showing the heating mechanism;

FIG. 18 is a schematic front view showing the clamping mechanism;

FIG. 19A is a schematic diagram of a receiving plate and a driving mechanism thereof showing a state where the receiving plate is retreated from the a tape passage groove;

FIG. 19B is a schematic diagram of the receiving plate and the driving mechanism thereof showing a state where the tape receiving plate is advanced into the tape passage groove;

FIG. 20 is a schematic diagram showing a driving mechanism for a loop forming mechanism and the supplying mechanism;

FIG. 21A is a schematic step chart of the tape binding device showing a state where a loop is formed of the tape;

FIG. 21B is a schematic process chart of the tape binding device showing a state where an end of the looped tape is sandwiched between a first clamp and the receiving plate;

FIG. 22A is a schematic process chart of the tape binding device showing a state where the loop is tightened about a material to be bound;

FIG. 22B is a schematic process chart of the tape binding device showing a state where an overlapped portion of the tape is sandwiched between a second clamp and the receiving plate;

FIG. 22C is a schematic process chart of the tape binding device showing a state where the overlapped portion of the tape is heat-sealed by pressing a heater thereagainst;

FIG. 23A is a schematic diagram of a driving mechanism for a placing unit according to another embodiment of the invention showing a state where the placing unit is at the lower position;

FIG. 23B is a schematic diagram of the driving mechanism for the placing unit of FIG. 23A showing a state where the placing unit is at the upper position;

FIG. 24 is an exploded perspective view showing a belt conveying mechanism and a fixed guide plate according to another embodiment of the invention; and

FIG. 25 is a schematic sectional view showing the belt conveying mechanism and the fixed guide plate of FIG. 24.

### DETAILED DESCRIPTION OF THE PREFERRED EMBODIMENTS

A preferred embodiment of the invention will be described with reference to the accompanying drawings.

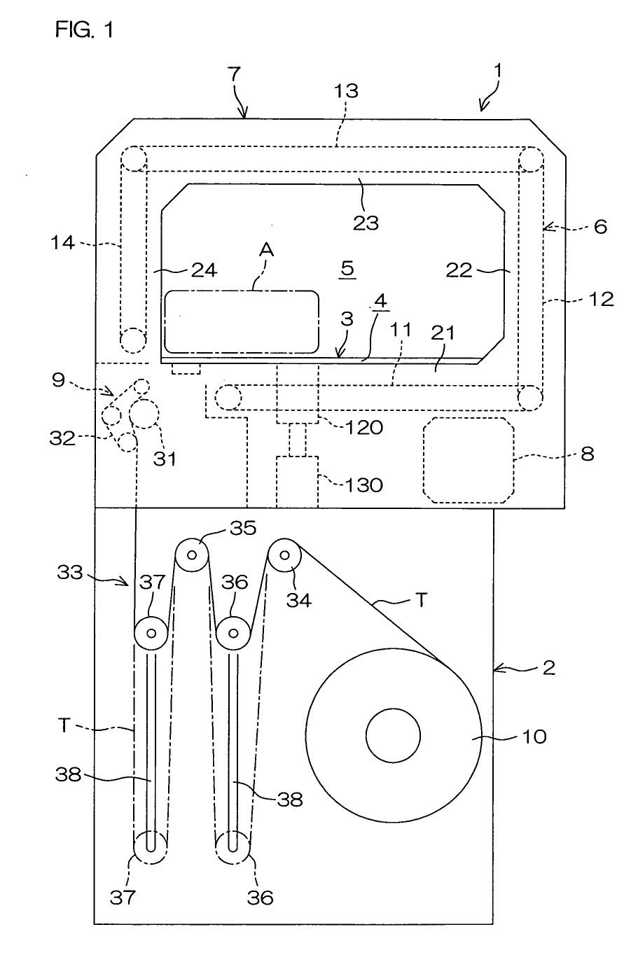

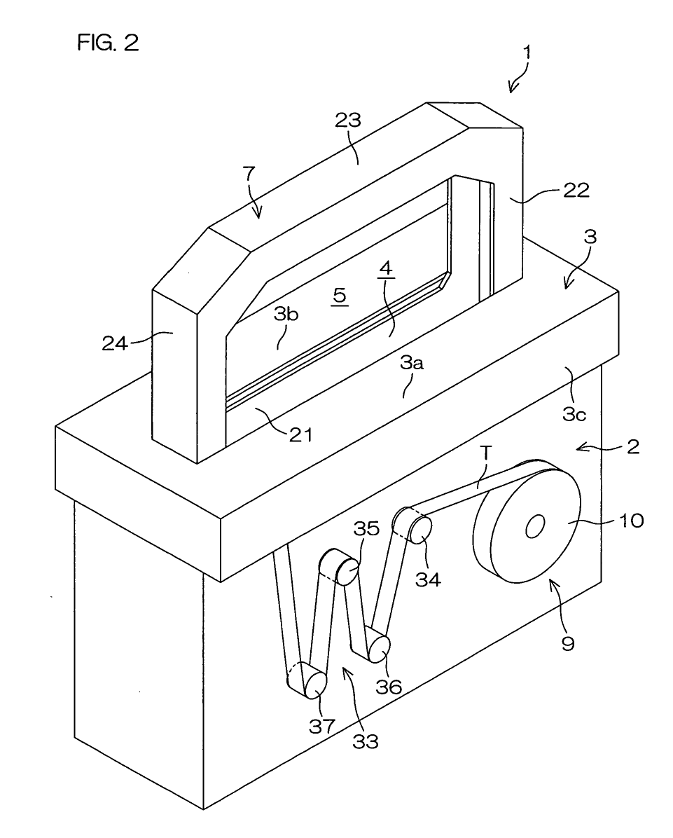

FIG. 1 is a schematic front view showing a tape binding device 1 according to one embodiment of the invention and FIG. 2 is a schematic perspective view thereof. Referring to FIG. 1, the tape binding device 1 includes a main body 2 and a table 3 disposed centrally of the main body 2 with respect to a height direction of the main body 2. As shown in FIG. 2, the table 3 is formed with a tape passage groove 4 that a tape T for binding a material to be bound passes above and below the table 3. The table 3 includes a front portion 3a and a rear portion 3b to sandwich across the tape passage groove 4 between front and rear sides. The table is also provided with a peripheral wall 3c extended downward from the table 3.

As shown in FIG. 1, the main body 2 is provided with a loop forming space 5 above the table 3, for forming with a loop at an end of the tape T. A loop forming mechanism 6 for forming the tape loop in the loop forming space 5 includes a negative pressure groove formation frame 7 arranged in a rectangular annular configuration, first to fourth belt conveying mechanisms 11 to 14, and an air suction pump 8 which sucks air via the negative pressure groove formation frame 7 for sticking the tape T to individual conveying belts of the belt conveying mechanisms 11 to 14 such that the tape T is sucked and conveyed to the individual conveying belts of the belt conveying mechanisms 11 to 14.

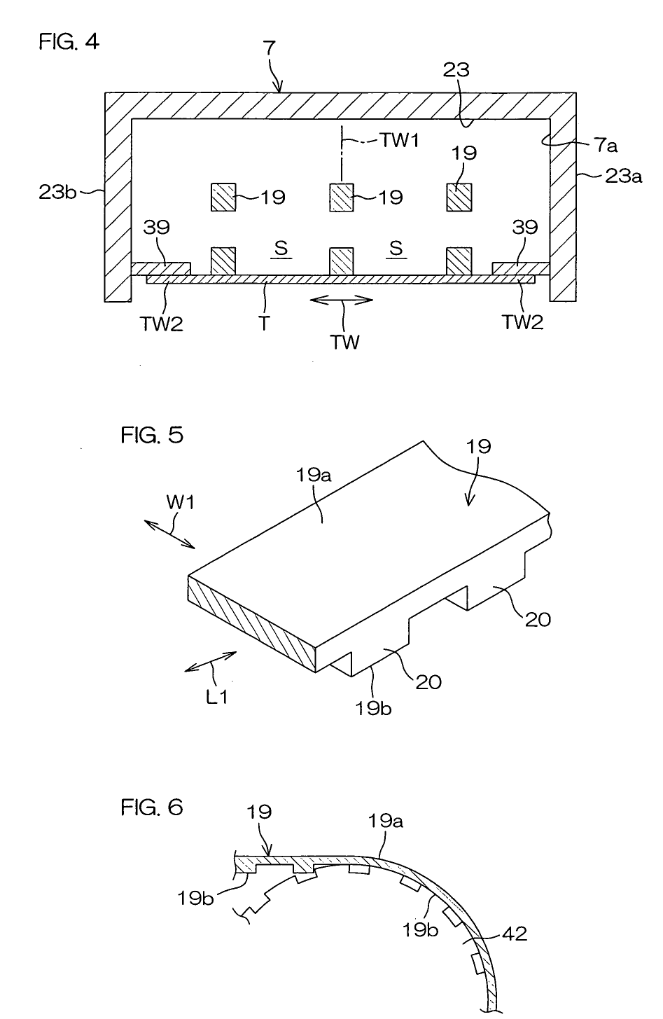

Specifically, the negative pressure groove formation frame 7 has a groove form in section and defines a negative pressure groove 7a, as shown in FIG. 4. As shown in FIG. 1 and FIG. 2, the negative pressure groove formation frame 7 includes a lower frame 21, a vertical frame 22, an upper frame 23 and a vertical frame 24. The lower frame 21, the vertical frame 22, the upper frame 23 and the vertical frame 24 are arranged in this order in a rectangular annular configuration. The lower frame 21 connects lower ends of a pair of vertical frames 22, 24, while the upper frame 23 connects upper ends of the pair of vertical frames 22, 24.

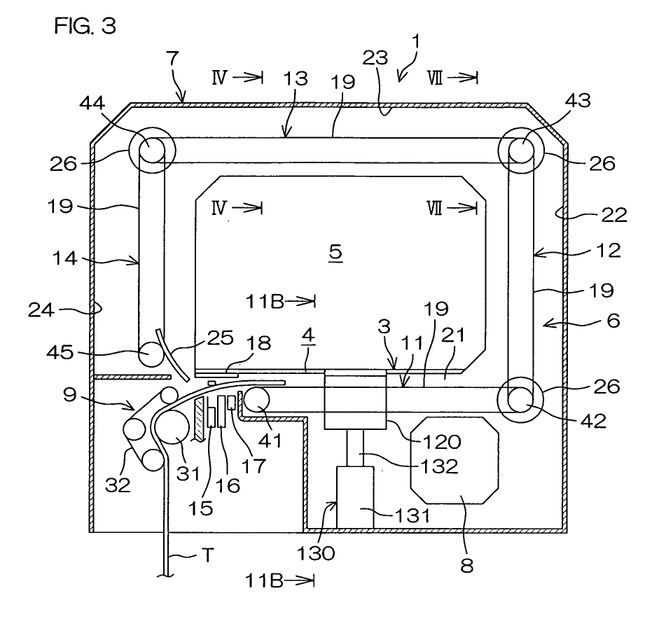

The paired vertical frames 22, 24 and the upper frame 23 are disposed above the table 3. The lower frame 21 is disposed below the table 3. As shown in FIG. 1 and FIG. 3, the first belt conveying mechanism 11 is accommodated in the lower frame 21, the second belt conveying mechanism 12 accommodated in the right vertical frame 22, the third belt conveying mechanism 13 accommodated in the upper frame 23, the fourth belt conveying mechanism 14 accommodated in the left vertical frame 24.

Referring to FIG. 3, each of the belt conveying mechanisms 11 to 14 includes a plurality of conveying belts 19 provided together. The conveying belts 19 of the first belt conveying mechanism 11 are wound between a first pulley 41 and a second pulley 42. The conveying belts 19 of the second belt conveying mechanism 12 are wound between the second pulley 42 and a third pulley 43. The conveying belts 19 of the third belt conveying mechanism 13 are wound between the third pulley 43 and a fourth pulley 44. The conveying belts 19 of the fourth belt conveying mechanism 14 are wound between the fourth pulley 44 and a fifth pulley 45.

In this manner, the conveying belts 19 of the first and second belt conveying mechanisms 11, 12 in adjoining relation are wound about the common second pulley 42. The conveying belts 19 of the second and third conveyor mechanisms 12, 13 in adjoining relation are wound about the common third pulley 43. The conveying belts 19 of the third and fourth conveyor mechanisms 13, 14 in adjoining relation are wound about the common fourth pulley 44. The first, second, third and fourth belt conveying mechanisms 11 to 14 are arranged in a rectangular configuration so as to line up in a conveyance direction L1, namely a counterclockwise direction as seen in FIG. 3.

Referring to FIG. 1 and FIG. 2, the belt binding device includes a supplying mechanism 9 for feeding the tape T to the loop forming mechanism 6. The supplying mechanism 9 includes a tape roll 10 rotatably supported by the main body 2.

Referring to FIG. 1 and FIG. 3, the supplying mechanism 9 includes a reciprocally rotatable conveying roller 31 and conveying belt 32 that convey the tape T with sandwiching the tape T therebetween in order to supply the loop forming mechanism 6 with the tape T paid out from the tape roll 10.

Referring to FIG. 1 and FIG. 2, the supplying mechanism 9 includes an accumulator mechanism 33 interposed between the tape roll 10 and the conveying belt 32 and capable of pooling a predetermined length of tape T.

The accumulator mechanism 33 includes a plurality of rollers 34 to 37. The upper rollers 34, 35 are fixed to places whereas the lower rollers 36, 37 are supported by the main body 2 vertically elevatable. Specifically, supporting shafts of the individual rollers 36, 37 are vertically movably supported by respective guide grooves 38 formed in the main body 2. Each of the rollers 36, 37 is also urged downward by an urging member (not shown) such as a weight or spring.

When the conveying roller 31 and conveying belt 32 are rotated forward (clockwise direction as seen in FIG. 1) so as to increase the tension of the tape T in the accumulator mechanism 33, the rollers 36, 37 are moved up against the urging member to upper positions represented by solid lines in FIG. 1. Thus, the pooled tape T in the accumulator mechanism 33 is sufficiently supplied to the loop forming mechanism 6.

On the other hand, when the conveying roller 31 and conveying belt 32 are rotated backward (counterclockwise direction as seen in FIG. 1) so as to decrease the tension of the tape T in the accumulator mechanism 33, the urging members operate to move down the rollers 36, 37 to lower positions represented by broken lines in FIG. 1. Thus, the predetermined length of tape T is pooled in the accumulator mechanism 33.

Referring to FIG. 3, a first clamping mechanism/cutting mechanism 15, a heating mechanism 16 and a second clamping mechanism 17 are disposed between the conveying roller 31 and a start end of the first belt conveying mechanism 11. Further, a receiving plate 18 is provided that is advanced from a rear side as seen in the drawing (position below the rear portion 3b of the table 3) into the tape passage groove 4 so as to be located above these first clamping mechanism/cutting mechanism 15, heating mechanism 16 and second clamping mechanism 17.

In the vicinity of the fifth pulley 45 of the fourth belt conveying mechanism 14, a guiding member 25 is disposed for guiding the tape T delivered by the conveying belts 19 of the fourth belt conveying mechanism 14 to the below the receiving plate 18. A part of the guiding member 25 is formed in a comb shape such as to enter respective spaces between adjoining conveying belts 19 of the fourth belt conveying mechanism 14.

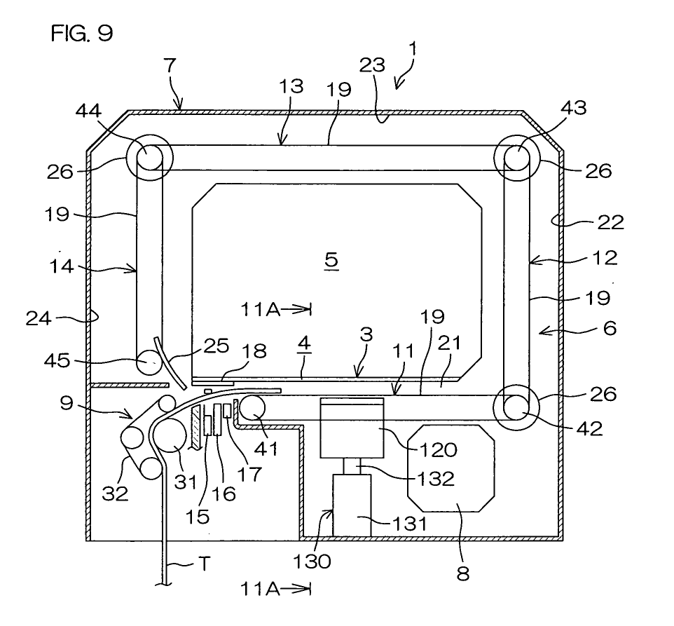

A placing unit 120 for placing the material to be bound A, and a driving mechanism 130 for shifting the placing unit 120 to an upper position shown in FIG. 3 and a lower position shown in FIG. 9 are disposed below the table 3.

As shown in FIG. 4, the conveying belts 19 of the third belt conveying mechanism 13 are arranged with air suction spaces S provided therebetween. The other belt conveying mechanisms 11, 12, 14 have the same arrangement, though not shown.

As shown in FIG. 5 and FIG. 6, the conveying belt 19 has a tape conveying surface 19a including an outside surface thereof and a pulley engagement surface 19b including an inside surface thereof. The pulley engagement surface 19b is formed with teeth 20 extended in a width direction W1 perpendicular to the conveyance direction L1 of the conveying belt 19. That is, the conveying belt 19 is constructed as a toothed belt (cogged belt) provided with the teeth 20 on the pulley engagement surface 19b. The pulleys 41 to 45 are each constructed as a toothed pulley. (Only the second pulley 42 is shown in FIG. 6.)

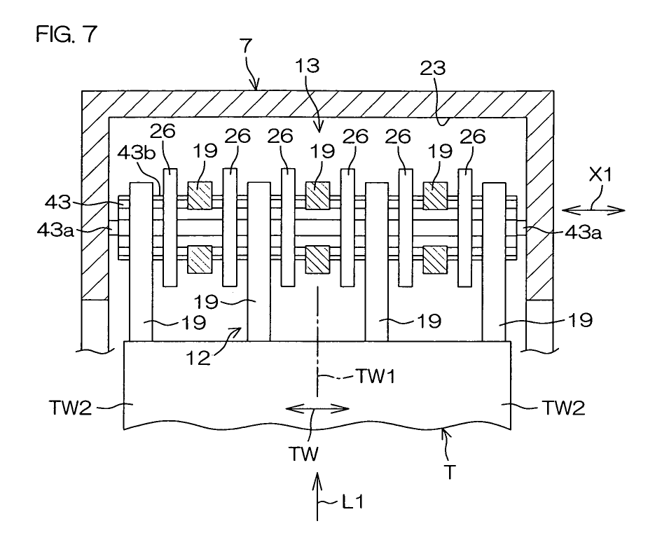

Referring to FIG. 7, the plural conveying belts 19 of the second belt conveying mechanism 12 and the plural conveying belts 19 of the third belt conveying mechanism 13 are wound about the common third pulley 43. A supporting shaft 43a of the third pulley 43 is rotatably supported by the negative pressure groove formation frame 7.

The plural conveying belts 19 of the second belt conveying mechanism 12 and the plural conveying belts 19 of the third belt conveying mechanism 13 are wound about the third pulley 43 alternately with one by one or more of the plural conveying belts of the second belt conveying mechanism 12 and the plural conveying belts of the third belt conveying mechanism 13 in an axial direction of the third pulley 43 (one by one in the example of FIG. 7).

Further, the conveying belts 19 of these belt conveying mechanisms 12, 13 are symmetrically arranged with respect to a center position TW1 of the tape width TW perpendicular to the conveyance direction L1 of the tape T. The same applies to the conveying belts 19 of the other belt conveying mechanisms 11, 14, that is, the belts are symmetrically arranged with respect to the center position TW1 of the tape width TW perpendicular to the conveyance direction L1 of the tape T.

In case of alternately arranging the conveying belts 19 of these belt conveying mechanisms 12, 13, when the second belt conveying mechanism 12 includes four conveying belts 19, the third belt conveying mechanism 13 includes three conveying belts 19, as shown in FIG. 7. Hence, three central conveying belts 19 are positioned along the center position TW1 of the tape width TW.

For example, the second belt conveying mechanism 12 and the third belt conveying mechanism 13 are each constructed with two conveying belts 19 and the two conveying belts 19 of the third belt conveying mechanism 13 are arranged between the two conveying belts 19 of the second belt conveying mechanism 12.

As shown in FIG. 7, the plural conveying belts 19 of the respective belt conveying mechanisms 12, 13 are symmetrically arranged with respect to the center position TW1 of the width TW of the tape T. Accordingly, the conveying belts 19 of the second belt conveying mechanism 12 may be disposed at a pair of ends TW2 of the width TW of the tape T, whereas the conveying belts 19 of the third belt conveying mechanism 13 must be slightly spaced away from the pair of ends TW2 of the width TW of the tape T. Hence, the distance is increased between a front wall 23a and rear wall 23b of the upper frame 23 and the conveying belt 19.

As shown in FIG. 4, therefore, it is preferable to guide a widthwise (TW) end of the tape T in the conveyance direction L1 (direction perpendicular to the drawing surface) for preventing unwanted flexure of the tape T using a guide plate 39 as a guiding member perpendicularly fixed to an inside surface of each of the front wall 23a and the rear wall 23b and extended in the conveyance direction L1 (direction perpendicular to the drawing surface, though not shown in FIG. 4).

Referring to FIG. 7, a plurality of annular plates 26 having a greater diameter than that of the third pulley 43 are mounted on an outer periphery 43b of the third pulley 43 rotatable together with the third pulley 43. The annular plate 26 is arranged between adjoining conveying belts 19 of the second belt conveying mechanism 12 and the third belt conveying mechanism 13.

Referring to FIG. 3, the annular plates 26 as a guiding member rotatable together with the second pulley 42 are arranged coaxially with the second pulley 42 about which the mutually adjoining conveying belts 19 of the first and second belt conveying mechanisms 11, 12 are wound. Further, the annular plates 26 as the guiding member rotatable together with the third pulley 43 are coaxially arranged with the third pulley 43 about which the mutually adjoining conveying belts 19 of the second and third belt conveying mechanisms 12, 13 are wound. Further, the annular plates 26 as the guiding member rotatable together with the fourth pulley 44 are arranged coaxially with the fourth pulley 44 about which the mutually adjoining conveying belts 19 of the third and fourth belt conveying mechanisms 13, 14 are wound.

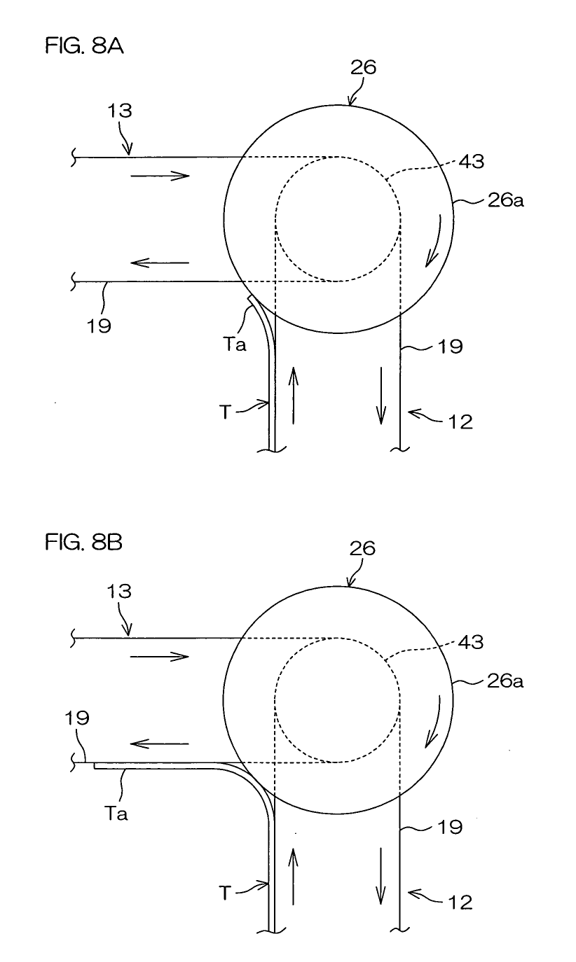

As shown in FIG. 8A, an end Ta of the tape T delivered by the conveying belts 19 of the second belt conveying mechanism 12 is stripped from the conveying belts 19 of the second belt conveying mechanism 12 by outer peripheries 26a of the annular plates 26 coaxially with the third pulley 43 and rotate together with and having the greater diameter than that of the third pulley 43. Thus, the direction of the tape T is changed so as to be transferred to the conveying belts 19 of the third belt conveying mechanism 13, as shown in FIG. 8B. The annular plates 26 mounted on the second pulley 42 and the fourth pulley 44 also work the same.

The annular plates 26 rotatable together with the second pulley 42 are arranged coaxially with the second pulley 42 about which the mutually adjoining conveying belts 19 of the first and second belt conveying mechanisms 11, 12 are wound. The annular plates 26 rotatable together with the third pulley 43 are arranged coaxially with the third pulley 43 about which the mutually adjoining conveying belts 19 of the second and third belt conveying mechanisms 12, 13 are wound. The annular plates 26 rotatable together with the fourth pulley 44 are arranged coaxially with the fourth pulley 44 about which the mutually adjoining conveying belts 19 of the third and fourth belt conveying mechanisms 13, 14 are wound.

As shown in FIG. 8A and FIG. 8B, the annular plates 26 arranged coaxially with the third pulley 43 about which the mutually adjoining conveying belts 19 of the second and third belt conveying mechanisms 12, 13 are wound are rotated together with the third pulley 43. When the annular plates 26 change the direction of the tape T, therefore, a relative speed between the peripheries of the annular plates 26 and the tape T is small. Accordingly, the annular plates 26 do not impose sliding resistance on the tape T so as to interfere with the tape conveyance.

Even if the tape T sticks to the peripheries of the annular plates 26 with the water that adheres to the tape T in binding a water-containing material to be bound A, such as tofu, the tape T can be favorably transferred to the subsequent third belt conveying mechanism 13 because the annular plates 26 are rotated together with the third pulley 43. This feature is also effective in a case where a thin tape T is electrostatically stuck to the peripheries of the annular plates 26.

Therefore, when the tape T is sucked and conveyed to the conveying belts 19 so as to form a rectangular loop TL, the loop TL of the tape T may be favorably formed. Thus, the favorable tape binding may also be accomplished in the case of binding the water-containing material to be bound A such as tofu and in the case of binding the material with the tape T that tends to be electrostatically stuck. Further, the structure is simplified because the annular plates 26 is simply mounted on the individual pulleys 42, 43, 44.

As shown in FIG. 7, the conveying belts 19 of the second belt conveying mechanism 12 and the conveying belts 19 of the third belt conveying mechanism 13 are arranged to alternate with each other in the axial direction of the third pulley 43 while each of the annular plates 26 is arranged between the conveying belt 19 of the second belt conveying mechanism 12 and the conveying belt 19 of the third belt conveying mechanism 13. Hence, the change of the direction of a wide tape T can be preferably performed. The same applies to the annular plates 26 on the second pulley 42 and the fourth pulley 44.

The above annular plates 26 may be integrally formed with each of the pulleys 42, 43, 44 from one material. The annular plates 26 including a separate member may also be mounted to each of the pulleys 42, 43, 44.

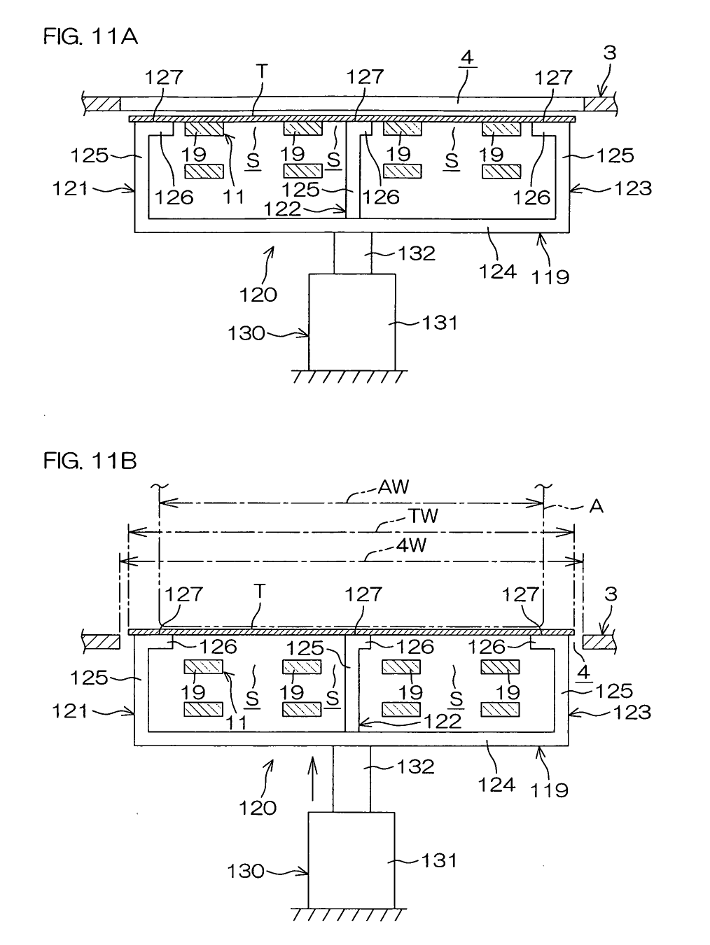

According to the embodiment, as shown in FIG. 11B, the width TW of the tape T is greater than the width AW of the material to be bound A (TW>AW). Hence, the width 4W of the tape passage groove 4 is greater than the width AW of the material to be bound A (4W>AW), so that the material to be bound A per se cannot be placed on the tape passage groove 4. On the other hand, the conveying belts 19 of the first belt conveying mechanism 11 of the loop forming mechanism 6 are disposed below the tape passage groove 4.

The embodiment is provided with the placing unit 120 to place the material to be bound A on the tape passage groove 4 without interfering with the loop formation by the conveying belts 19 of the first belt conveying mechanism 11, and with the driving mechanism 130 for driving the unit.

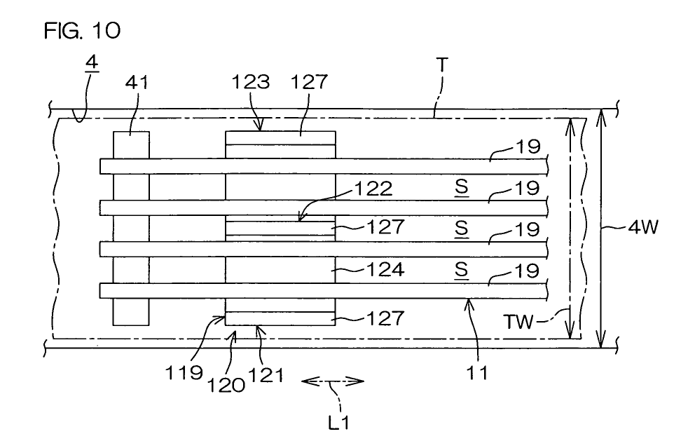

A more detailed description is made with reference to FIG. 10, FIG. 11 and FIG. 11B. The placing unit 120 includes a plurality of placing members 121 to 123 and a connecting member 124 for connecting these placing members 121 to 123. The placing members 121 to 123 are arranged spaced apart in a width direction of the tape passage groove 4.

The placing members 121 to 123 each include a vertical plate 125 parallel to the conveyance direction L1 of the conveying belt 19 (see FIG. 10; the direction perpendicular to the drawing surfaces of FIG. 11A and FIG. 11B), and a horizontal plate 126 extended at an upper end of the vertical plate 125. A top surface of the horizontal plate 126 constitutes a placing portion 127. In other words, the placing portions 127 are provided at the top surfaces of the respective placing members 121 to 123.

The connecting member 124 interconnects lower ends of the vertical plates 125 of the plural placing members 121 to 123. The plural placing members 121 to 123 are adapted to be collectively driven by the driving mechanism 130 via the connecting member 124 to the lower position shown in FIG. 11A and to the upper position shown in FIG. 11B.

As the driving mechanism 130, examples may include a direct operated electromagnetic actuator, such as a solenoid or direct operated motor, which includes a stationary portion 131 and a movable shaft 132 advancing/retreating from/to the stationary portion 131. An upper end of the movable shaft 132 is connected to a lower side of the connecting member 124.

The placing members 121, 123 are disposed outward of the conveying belts 19 on both ends of the first belt conveying mechanism 11. The placing member 122 is inserted through a space S between the adjoining conveying belts 19.

The placing portions 127 are designed to be level with or slightly lower than upper sides of the conveying belts 19 when the placing members 121 to 123 are at the lower position as shown in FIG. 11A.

In the state where the placing members 121 to 123 are at the lower position, the tape T is sucked and conveyed to form the loop TL of the tape T.

After the formation of the loop TL, the movable shaft 132 of the driving mechanism 130 is extended to raise the placing unit 120, so that the placing members 121 to 123 together with a part of the tape T are shifted to the upper position, as shown in FIG. 11B.

The placing portions 127 of the placing members 121 to 123 shifted to the upper position are raised into the tape passage groove 4 to be level with or substantially level with a top surface of the table 3. The material to be bound A is placed on the tape T along the placing portions 127 of the placing members 121 to 123 at the upper position. Subsequently, the loop TL of tape T is tightened up to bind the material to be bound A.

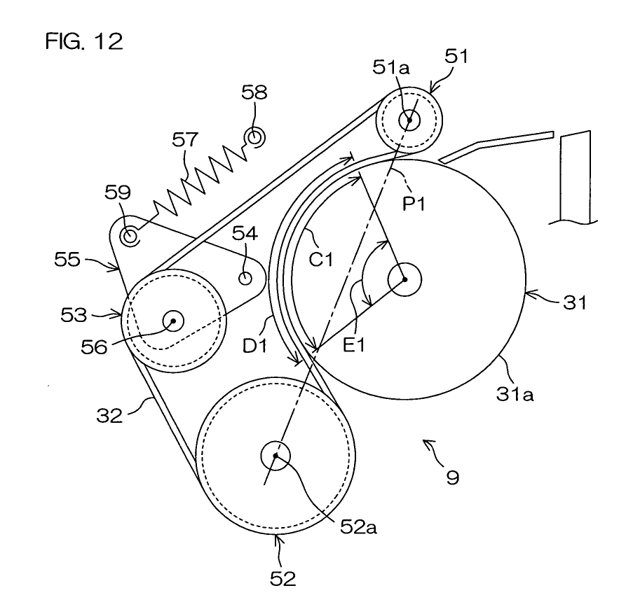

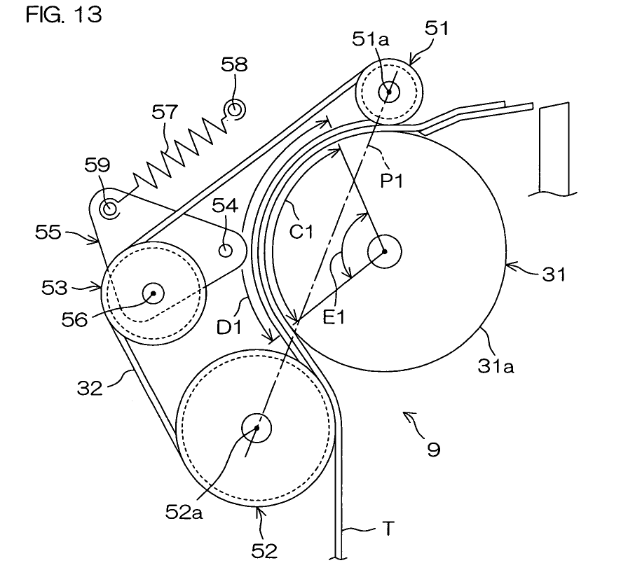

Referring to FIG. 12 and FIG. 13, the conveying belt 32 includes an endless belt wound about a first pulley 51, a second pulley 52 and a tensioner pulley 53. The conveying belt 32 includes a region wound between the first pulley 51 and the second pulley 52, and within the region a region D1 is included that is curved along a predetermined region C1 of a peripheral surface 31a of the conveying roller 31.

A central angle E1 corresponding to the predetermined region C1 of the peripheral surface 31a of the conveying roller 31 may preferably be in the range of 45° to 150°, more preferably of 90° to 120° or further more preferably of 105° to 115°.

The conveying belt 32 is capable of evenly pressing the peripheral surface 31a of the conveying roller 31 because the conveying belt 32 is pressed against the peripheral surface 31a of the conveying roller 31 by the tension of the conveying belt 32 itself.

The tensioner pulley 53 functions to apply tension to the conveying belt 32. Specifically, the tensioner pulley 53 is rotatably supported about its supporting shaft 56 by a supporting member 55 rotatably supported about a support 54 by the main body 2. The tensioner pulley 53 is arranged to be spaced apart in a predetermined distance from the support 54.

The supporting member 55 is urged in a rotating direction by, for example, a tension coil spring 57 as an urging member, so that the tensioner pulley 53 is urged in a direction to apply the tension to the conveying belt 32. The tension coil spring 57 is disposed between, for example, a shaft 58 as an engagement portion provided on the main body 2 and a shaft 59 as an engagement portion provided at the supporting member 55.

A plane P1 including a central axis 51a of the first pulley 51 and a central axis 52a of the second pulley 52 is adapted to intersect the conveying roller 31. A positional relation between the first and second pulleys 51, 52 supporting the conveying belt 32 and the conveying roller 31 is set in this manner can realize the configuration wherein the conveying belt 32 is provided with the curved region D1 and the configuration wherein the conveying belt 32 is pressed against the peripheral surface 31a of the conveying roller 31 by the tension of the conveying belt 32 itself.

Since the conveying belt 32 includes the region D1 curved along the peripheral surface 31a of the conveying roller 31, as shown in FIG. 13, a large contact area can be secured between the conveying belt 32 and the conveying roller 31 and the tape T with respect to the conveyance direction of the tape T.

Therefore, the tape T can be securely sandwiched between the conveying roller 31 and the conveying belt 32 without increasing the pressing force on the wide tape T requiring conveying force to favorably convey the tape T without slipping. The tape T may be prevented from damage because it is unnecessary to increase the pressing force on the tape T. Because the conveying roller 31 and the conveying belt 32 are less susceptible to deterioration such as wear, durability can be improved.

Particularly, the device can apply the tension to the conveying belt 32 by the tensioner pulley 53. If the conveying belt 32 is stretched out over time, the stretch can be absorbed. Therefore, the device can stably maintain the pressing force of conveying belt 32 and ensure a stable conveying force over an extended period of time.

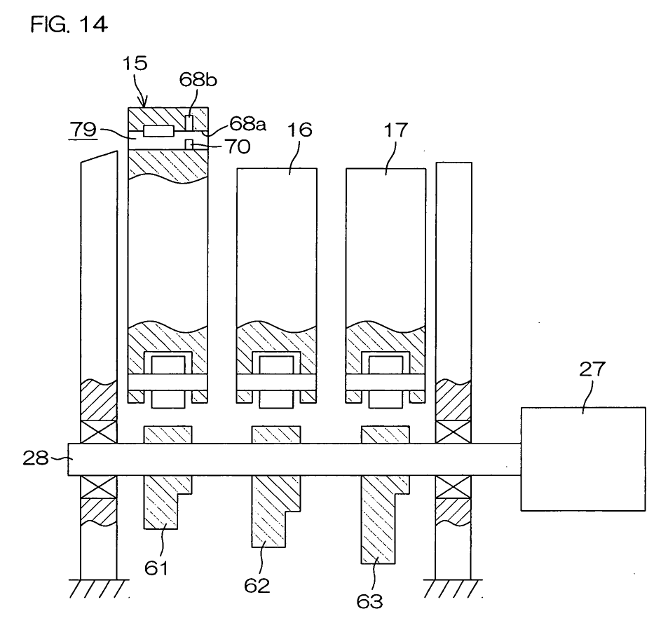

Referring to FIG. 14, the first clamping mechanism/cutting mechanism 15, the heating mechanism 16 and the second clamping mechanism 17 are driven into upward and downward movement by first, second and third cams 61, 62 and 63, respectively, rotated together with a rotating shaft 28 of an electric motor 27 as a driving member.

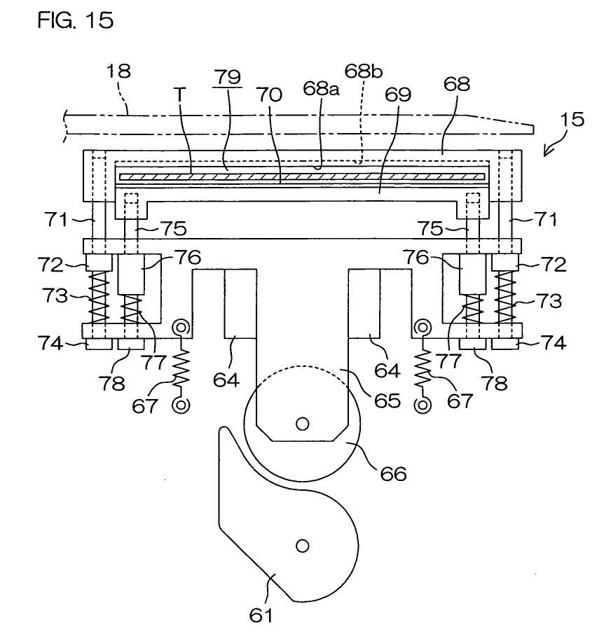

Referring to FIG. 15, the first clamping mechanism/cutting mechanism 15 includes: a support 65 vertically movably supported by a pair of guides 64 fixed to the main body 2; a cam follower 66 rotatably supported on a lower part of the support 65 and vertically movable together with the support 65; an urging member 67 including, for example, a tension coil spring for urging the support 65 downward; a first clamp 68 vertically movably supported by the support 65 and capable of sandwiching the tape T between a lower side of the receiving plate 18 and itself; a cutter supporting member 69 vertically movably supported by the support 65; and a cutter 70 fixed on a top of the cutter supporting member 69 and cutting the tape T by advancing into a cutter entry groove 68b (see FIG. 14) formed in a lower surface 68a of the first clamp 68.

A shaft 71 moving together with the first clamp 68 penetrates the support 65. A large diameter portion 72 provided on the shaft 71 is urged upward by an urging member 73 including, for example, a compression coil spring fitted on the shaft 71 whereby the first clamp 68 is urged upward. A stopper 74 is provided on a lower end of the shaft 71 for preventing the shaft 71 from separation from the support 65.

A shaft 75 moving together with the cutter supporting member 69 penetrates the support 65. A large diameter portion 76 provided on the shaft 75 is urged upward by an urging member 77 including, for example, a compression coil spring fitted on the shaft 75 whereby the cutter supporting member 69 is urged upward. A stopper 78 is provided on a lower end of the shaft 75 for separation the shaft 75 from disengaging from the support 65.

As pushed up by the cam 61, the support 65, the cutter supporting member 69 and the first clamp 68 move up together against the urging member 67 so that the tape T is first sandwiched between the first clamp 68 and the lower side of the receiving plate 18. Thus, the first clamp 68 is positioned at the upper position by the receiving plate 18 so as to be restricted in the upward movement. A front end 18a of the receiving plate 18 is received by a restricting member 30 so as to be restricted in the upward movement.

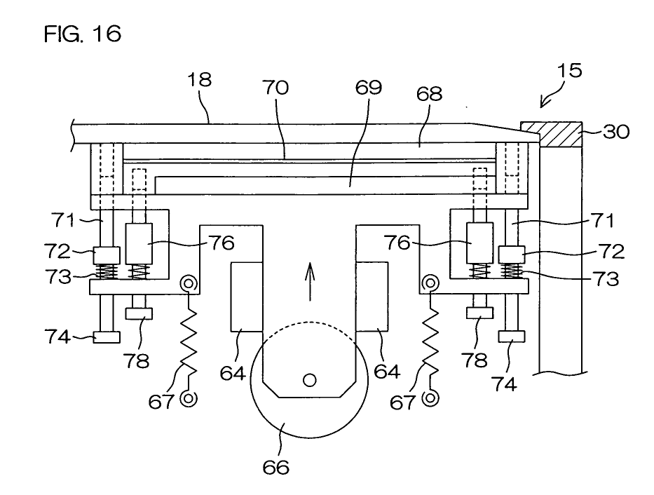

Subsequently, the support 65 and the cutter supporting member 69 move up as further pushed up by the cam 61. As shown in FIG. 15, the tape T inserted through a tape insertion hole 79 formed between the cutter 70 on the top of the cutter supporting member 69 and the lower surface 68a of the first clamp 68 is pressed into the cutter entry groove 68b in the lower surface 68a of the first clamp 68 so that the tape is cut as shown in FIG. 16.

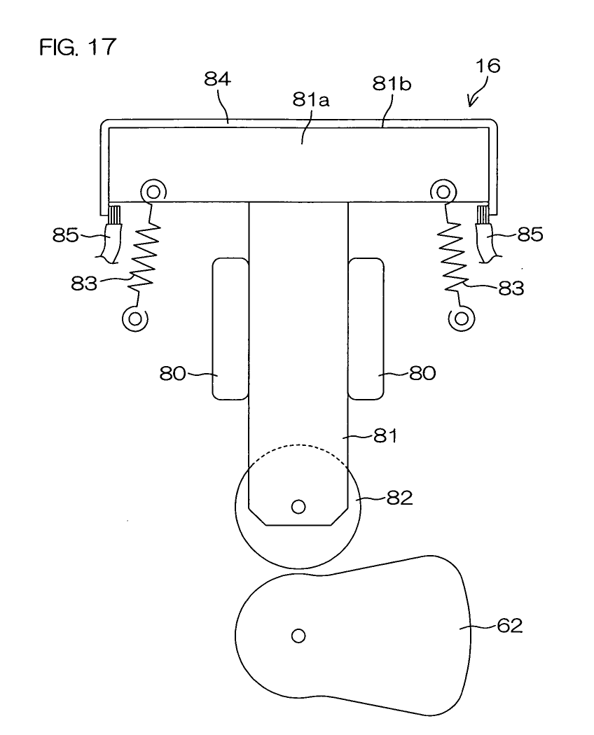

Referring to FIG. 17, the heating mechanism 16 includes: a T-shaped support 81 vertically movably supported by a pair of guides 80 fixed to the main body 2; a cam follower 82 rotatably supported on a lower part of the support 81 and vertically moved together with the support 81; an urging member 83 including, for example, a tension coil spring for urging the support 81 downward; a heater 84 including, for example, a planar heater provided at least on an upper surface 81b of a heater support 81a on an upper part of the support 81; and an electric wire 85 for supplying electric power to the heater 84.

As pushed up by the cam 62, the support 81 and the heater 84 move up together against the urging member 83, so that an overlapped portion of the tape T is pressed against the lower side of the receiving plate 18 and heated by the heater 84. As a result, the overlapped portion of the tape T is heat-sealed.

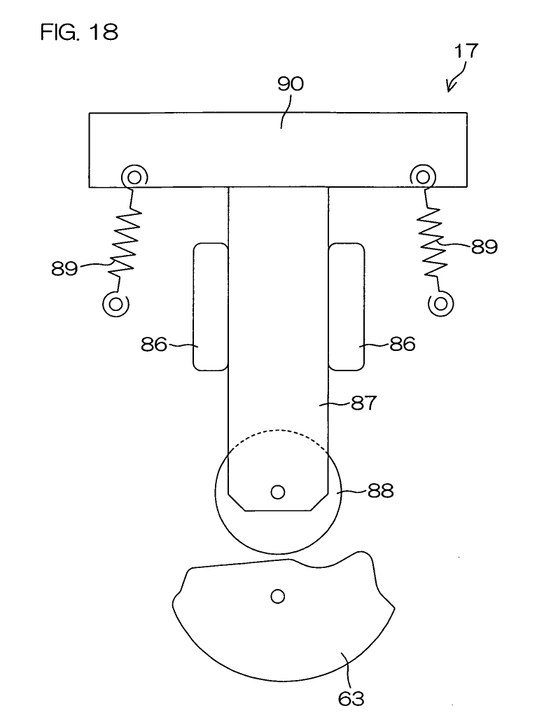

Referring to FIG. 18, the second clamping mechanism 17 includes: a support 87 vertically movably supported by a pair of guides 86 fixed to the main body 2; a cam follower 88 rotatably supported on a lower part of the support 87 and vertically moved together with the support 87; an urging member 89 including, for example, a tension coil spring for urging the support 87 downward; and a second clamp 90 shaped like a transversely elongated bar fixed to a top of the support 87 and abuttable against the lower side of the receiving plate 18.

As pushed up by the cam 63, the support 87 and the second clamp 90 move up together against the urging member 89 so that the end of the tape T is sandwiched between the second clamp 90 and the lower side of the receiving plate 18.

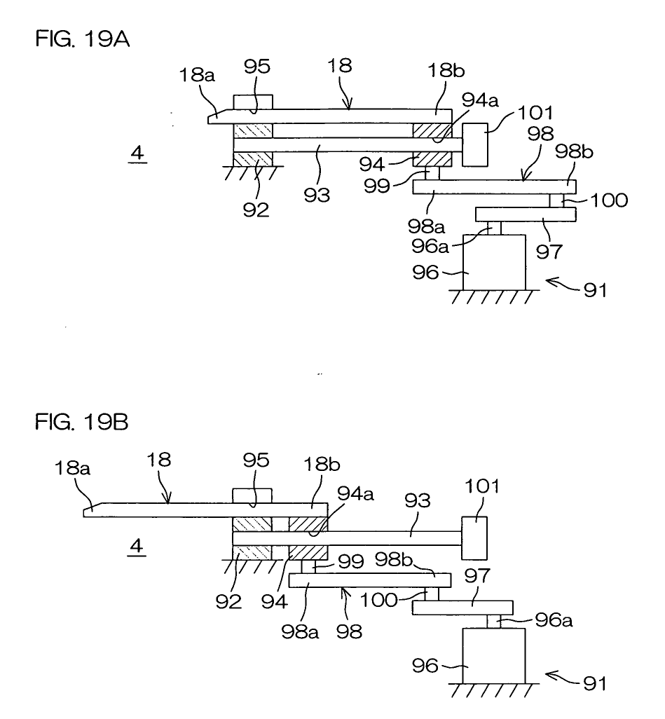

Referring to FIG. 19A, the receiving plate 18 is extended in a front/rear direction and is driven forward and backward by a driving mechanism 91. The driving mechanism 91 includes a guide shaft 93 having one end thereof fixed to a supporting block 92 fixed to the main body 2 and extended in the direction. A rear end 18b of the receiving plate 18 is fixed to a movable body 94 adapted movable by the guide shaft 93 in an axial direction of the guide shaft 93. The movable body 94 includes a through-hole 94a through which the guide shaft 93 relatively slidably penetrates. A stopper 101 is provided to a rear end of the guide shaft 93 for preventing the movable body 94 from separation from the guide shaft 93.

The supporting block 92 includes a receiving plate insertion groove 95 which supports the receiving plate 18 movable for the back-and-forth sliding. The front end 18a of the receiving plate 18 is advanced forward through the receiving plate insertion groove 95.

The driving mechanism 91 includes: an electric motor 96 as a driving member supported by the main body 2; a pivoting member 97 pivoting together with a rotating shaft 96a of the electric motor 96; and a connecting arm 98 connecting the pivoting member 97 and the movable body 94. The connecting arm 98 has one end 98a thereof rotatably connected to the movable body 94 via a pivot 99 and has the other end 98b thereof connected to the pivoting member 97 via a pivot 100. The pivot 100 is disposed on the rotating member 97 at place spaced apart in a predetermined distance from the rotating shaft 96a of the electric motor 96.

The rotational motion of the electric motor 96 is converted to the linear motion of the receiving plate 18 by a crank mechanism employing the pivoting member 97 and the connecting arm 98 whereby a great quantity of front/rear movement of the receiving plate 18 is secured to cope with the case where the wide tape T is used.

The receiving plate 18 is adapted to move between a forward position to advance into the tape passage groove 4 for receiving the material to be bound A, as shown in FIG. 19B and a backward position to retreat from the tape passage groove 4, as shown in FIG. 19A.

Next, description is made on a tape binding operation of the tape binding device 1. First, the loop TL is formed of the tape T in a state where the placing unit 120 is located at the lower position. Specifically, the conveying roller 31 and the conveying belt 32 of the supplying mechanism 9 rotate forward to feed the tape T to the loop forming mechanism 6. Accordingly, the air suction pump 8 is driven to produce negative pressure in the individual frames 21 to 24 of the negative pressure groove formation groove 7. The conveying roller 31 of the supplying mechanism 9, the first pulley 41 of the first belt conveying mechanism 11 and the fifth pulley 45 of the fourth belt conveying mechanism 14 are driven by the same driving mechanism 110.

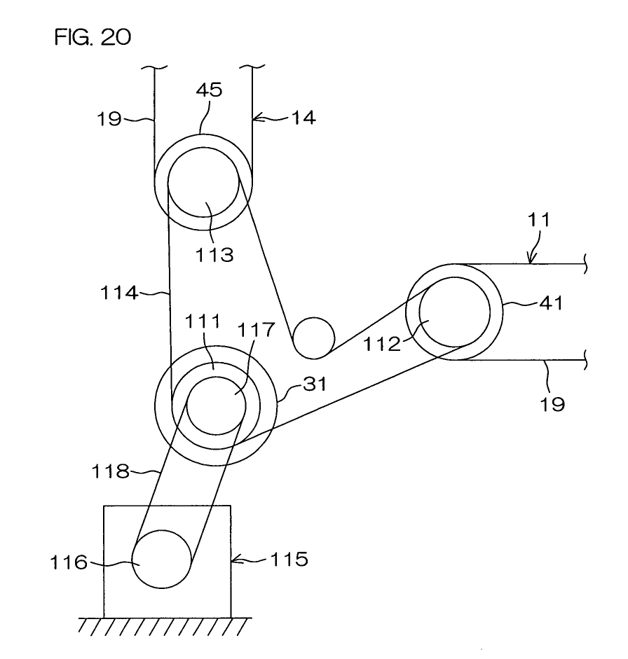

Specifically, a pulley 111 coaxially rotatable together with the conveying roller 31, a pulley 112 coaxially rotatable together with the first pulley 41 of the first belt conveying mechanism 11, and a pulley 113 coaxially rotatable together with the fifth pulley 45 of the fourth belt conveying mechanism 14 are provided as shown in FIG. 20. A common endless belt 114 is wound about these pulleys 111, 112, 113.

A belt 118 is wound between a driving pulley 116 driven by an electric motor 115 as a driving member and a pulley 117 rotated together with the pulley 111. The pulley 111 is driven by the electric motor 115 via the belt 118, whereby the pulleys 112, 113 are driven via the belt 114 accordingly.

The conveying roller 31 of the supplying mechanism 9 is driven by driving the pulley 111, while the conveying belt 32 is driven followingly with the conveying roller 31. The first pulley 41 as the first belt conveying mechanism 11 and the fifth pulley 45 as the fourth belt conveying mechanism 14 are driven, by driving the pulleys 112, 113. That is, the first pulley 41 as the start point and the fifth pulley 45 as the terminal point of the belt conveying mechanisms 11 to 14 are driven, whereby the whole of the belt conveying mechanisms 11 to 14 are driven.

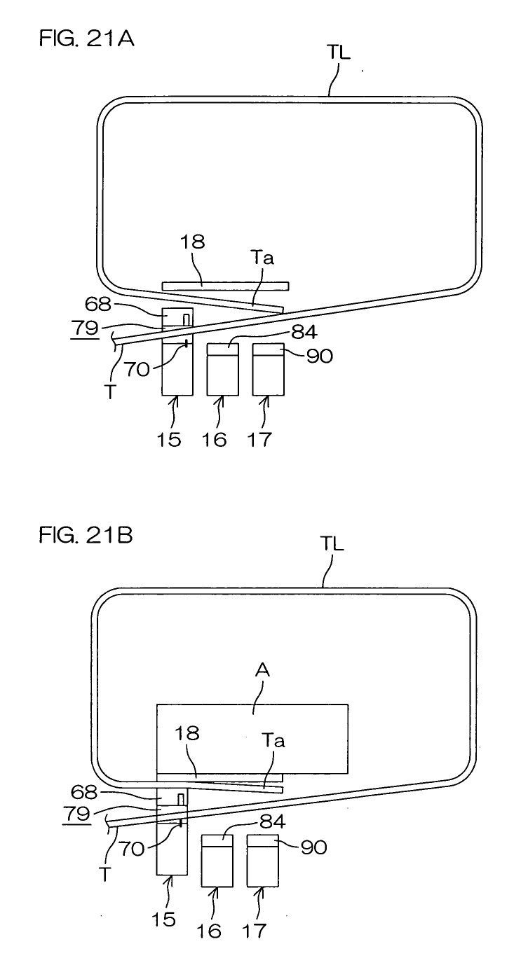

Thus, the end of the tape T is sequentially transferred to the first belt conveying mechanism 11, the second belt conveying mechanism 12, the third belt conveying mechanism 13 and the fourth belt conveying mechanism 14, so that the loop T1 of tape T is formed as shown in FIG. 21A.

Subsequently, as shown in FIG. 21B, the end Ta of the tape T is sandwiched between the raised first clamp 68 of the first clamp mechanism/cutting mechanism 15 and the receiving plate 18.

Subsequently, as shown in FIG. 11B, the placing unit 120 is raised so that the placing members 121 to 123 are shifted to the upper position.

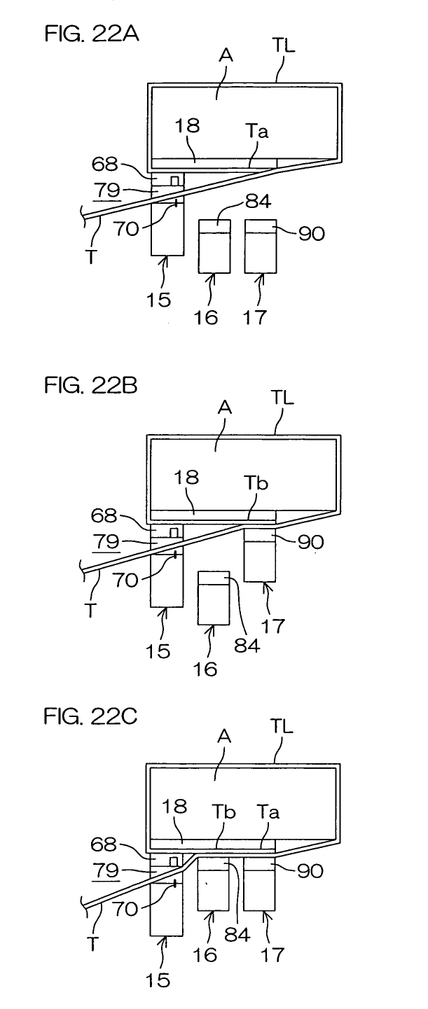

Subsequently, the material to be bound A is placed on the receiving plate 18 shown in FIG. 22A and the tape T on the placing portions 127 shown in FIG. 11B.

Subsequently, driven of the air suction pump 8 is stopped to terminate sticking of the tape to the conveying belts 19 of the individual belt conveying mechanisms 11 to 14. At the same time, the conveying roller 31 and the conveying belt 32 are rotated backward to tighten up the loop TL to shape the tape T to follow the periphery of the material to be bound A.

Subsequently, as shown in FIG. 22B, the overlapped portion Tb of the tape T is sandwiched between the raised second clamp 90 of the second clamping mechanism 17 and the lower side of the receiving plate 18. As shown in FIG. 22C, the raised heater 84 of the heating mechanism 16 heatingly presses the overlapped portion Tb of the tape T against the lower side of the receiving plate 18 so as to heat-seal the overlapped portion Tb of the tape T.

Though not shown, the raised cutter 70 of the first clamping mechanism/cutting mechanism 15 cut a surplus length of the tape T in substantial synchronism with or in a slightly delayed timing with the operation of the heater 84. Thereafter, the receiving plate 18 is retreated from the tape passage groove 4 and the binding operation is completed.

After the material thus bound A is discharged, the placing unit 120 is shifted to the lower position again.

According to the embodiment as described above, the material to be bound A can be placed on the placing portion 127 of the placing member 122 advanced above conveying belts 19 through the space S between the conveying belts 19 of the first belt conveying mechanism 11 disposed under the table 3 and on the placing portions 127 of the placing members 121, 123 on the opposite sides sandwiching the plural conveying belts 19. Therefore, even the material to be bound A having a smaller width AW than a width TW of the tape T may be prevented from falling into the tape passage groove 4. Accordingly, binding is practically possible using the tape T having a greater width than that of the material to be bound A.

The plural placing members 121 to 123 including the respective placing portions 127 are provided while the driving mechanism 130 collectively drives the plural placing members 121 to 123 via the connecting member 124 interconnecting the plural placing members 121 to 123. Hence, the structure is simplified.

As shown in FIG. 11A, the arrangement is made such that the placing portions 127 are retreated from places above the conveying belts 19 of the first belt conveying mechanism 11 when the placing members 121 to 123 are shifted to the lower position and that the loop TL is formed by the loop forming mechanism 16 in this state. This prevents the placing members 121 to 123 from interfering with the loop formation by the loop forming mechanism 16.

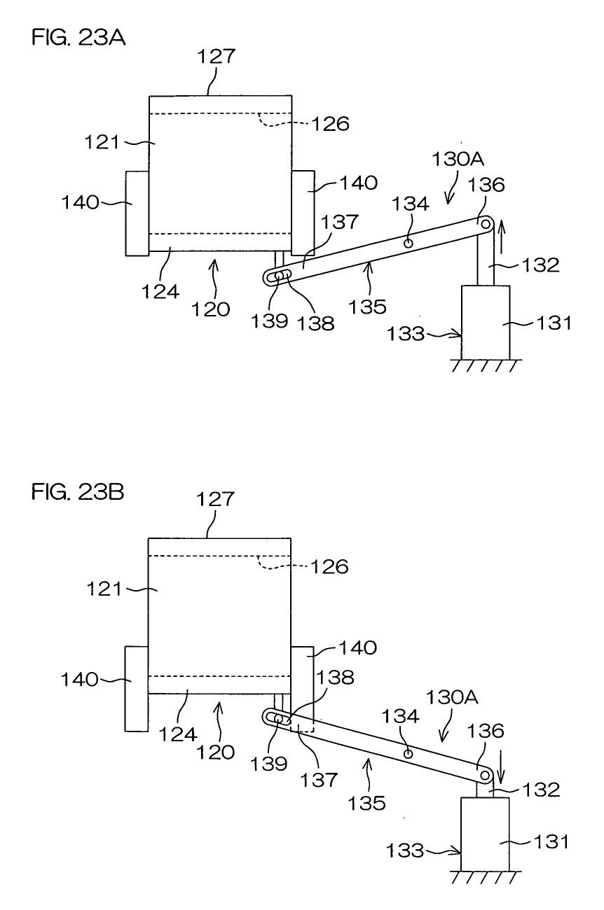

FIG. 23A and FIG. 23B illustrate a driving mechanism 130A of the placing unit as a modification. The driving mechanism 130A is arranged such that a driving member 133 including the stationary portion 131 and the movable shaft 132 drives the placing unit 120 via a swing arm 135 swingable about a support 134. Specifically, the swing arm 135 has one end 136 thereof rotatably attached to an upper end of the movable shaft 132. A supporting shaft 139 formed at a lower end of the connecting member 124 of the placing unit 120 is loosely fitted in a support hole 138 formed with an elongate hole formed in the other end 137 of the swing arm 135. The supporting shaft 139 extends in a direction perpendicular to the conveyance direction L1.

The placing unit 120 is provided with guides 140 for guiding the placing members 121, 123 on the opposite sides thereof, for example, in order that the placing unit 120 may move up or down without tilting.

As shown in FIG. 23A, the placing unit 120 is shifted to the lower position by extending the movable shaft 132. The placing unit 120 is shifted to the upper position by retracting the movable shaft 132.

According to the embodiment, even though the movable shaft 132 has a small stroke, a sufficient quantity of up/down stroke of the placing unit 120 can be secured by setting the position of the support 134.

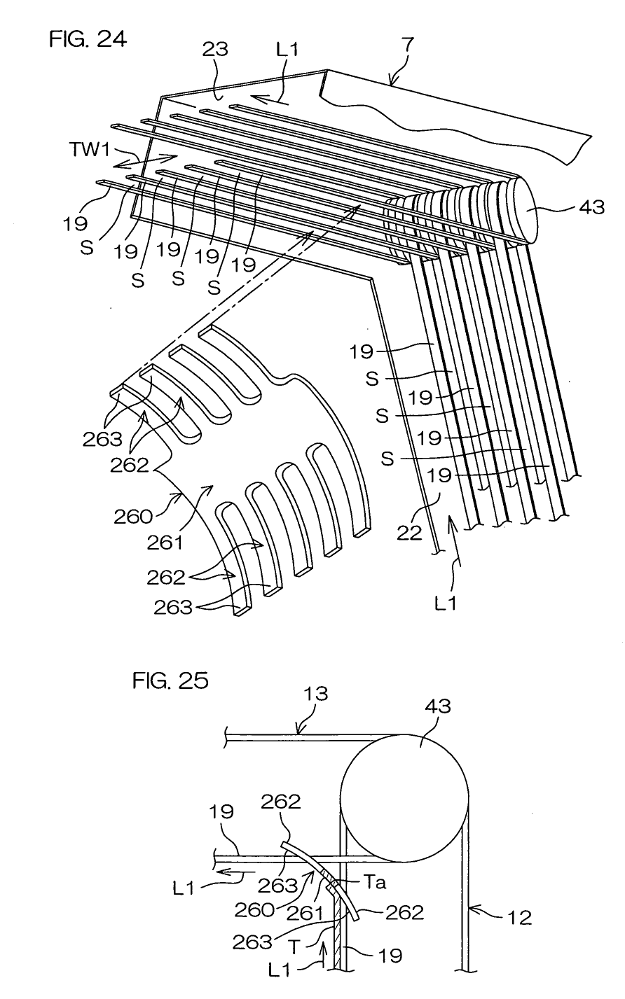

The foregoing embodiments employ the annular plates 26 rotating together with the third pulley 43 as the guiding member for facilitating the change of direction of the tape T from the second belt conveying mechanism 12 to the third belt conveying mechanism 13 adjoining each other in the conveyance direction L1. However, the annular plates 26 may be replaced by a fixed guide plate 260 as shown in FIG. 24.

The fixed guide plate 260 as the guiding member includes a main body 261 and a plurality of guiding pieces 262. The main body opposes an outer periphery of the third pulley 43 fixed to the negative pressure formation frame 7 and serving as the common pulley. The guiding pieces 262 extend from the main body 261 into the spaces S between the conveying belts 19. The guiding piece 262 includes an inclined guiding surface 263 inclined relative to the conveyance direction L1 of the tape T and abuttable against the tape end Ta in the conveyance direction L1 of the tape T.

According to this embodiment, the fixed guide plate 260 is used as the guiding member. However, the guiding pieces 262 of the fixed guide plate 260 are inserted aslant into the spaces S between the conveying belts 19. Hence, the end Ta of the tape T conveyed by the conveying belts 19 does not collide against end faces of the guiding pieces 262. That is, the end Ta of the tape T is smoothly stripped from the conveying belts 19 of the second belt conveying mechanism 12 by the inclined guiding surfaces 263 of the guiding pieces 262 and is favorably transferred to the conveying belts 19 of the third belt conveying mechanism 13.

While the invention has been described in greater details by way the specific examples thereof, it is apparent that changes, modifications and equivalents thereof will occur to those skilled in the art who have understood the above contents. The scope of the invention, therefore, is to be construed as defined by the appended claims and their equivalents.

The present application is based on Japanese Patent Application No. 2007-340918 filed with Japanese Patent Office on Dec. 28, 2007, and the whole disclosure thereof is incorporated herein by reference.

What is claimed is:

1. A tape binding device comprising:
a table formed with a tape passage groove allowing to pass a tape having a greater width than a width of a material to be bound;
placing members capable of placing the material to be bound thereon that is located above the tape passage groove;
a driving mechanism for driving the placing members to an upper position and a lower position; and
a loop forming mechanism including an air suction pump and a plurality of belt conveying mechanisms arranged in an annular configuration to form a loop of the tape,
wherein each of the plurality of belt conveying mechanisms includes a plurality of conveying belts extended in parallel along a conveyance direction of the tape and provided with spaces to be spaced apart in a direction perpendicular to the conveyance direction, and the air suction pump sucks air through the spaces thereby sucking the tape to the conveying belts,
wherein the plurality of belt conveying mechanisms include a first belt conveying mechanism disposed below the table,
wherein the placing members include a plurality of placing portions capable of placing the material to be bound thereon above the conveying belts of the first belt conveying mechanism when the placing members are shifted to the upper position, and
wherein at least one of the placing portions is arranged to advance above the conveying belts through a space between the corresponding conveying belts of the first belt conveying mechanism.

2. A tape binding device according to claim 1, wherein the plurality of placing members each including the placing portion are provided,
wherein the driving mechanism drives the plurality of placing members via a connecting member interconnecting the plurality of placing members.

3. A tape binding device according to claim 1, wherein the placing portions are retreated from the upper position above the conveying belts of the first belt conveying mechanism when the placing members are shifted to the lower position.

4. A tape binding device according to claim 3, wherein the loop is formed by the loop forming mechanism in a state where the placing portions are retreated from the upper position above the conveying belts of the first belt conveying mechanism.
